(19) United States
(12) Patent Application Publication
(10) Pub. No.: US 2026/0080290 A1
(43) Pub. Date: Mar. 19, 2026

(54) QUANTUM PROCESS LEARNING BASED ON GRADIENT VALUE ESTIMATES

(71) Applicant: International Business Machines Corporation, Armonk, NY (US)

(72) Inventor: Ewout van den Berg, Bronxville, NY (US)

(21) Appl. No.: 18/824,663

(22) Filed: Sep. 4, 2024

(51) Int. Cl. G06N 10/60

(52) U.S. Cl. CPC G06N 10/60

(57) ABSTRACT

One or more systems, devices, computer program products and/or computer-implemented methods of use provided herein relate to quantum process learning based on gradient value estimates. A system can comprise a memory that can store computer executable components. The system can further comprise a processor that can execute the computer executable components stored in the memory, where the computer executable components can comprise a measurement component that generates respective expectation values by measuring a plurality of observables at respective discrete time points for a plurality of initial quantum states in a quantum system. The computer executable components can also comprise a computation component that can compute a gradient based on respective expectation values corresponding to respective discrete time points. The computer executable components can further comprise an estimation component that can estimate a set of gradient values by evaluating the gradient at a set of time points.

### BACKGROUND

The subject disclosure relates to quantum computing and, more specifically, to learning a quantum process based on gradient value estimates.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable quantum process learning based on gradient value estimates are discussed.

According to an embodiment, a system is provided. The system can comprise a memory that can store computer executable components. The system can further comprise a processor that can execute the computer executable components stored in the memory, where the computer executable components can comprise a measurement component that generates respective expectation values by measuring a plurality of observables at respective discrete time points for a plurality of initial quantum states in a quantum system. The computer executable components can further comprise a computation component that can compute a gradient based on respective expectation values corresponding to respective discrete time points. The computer executable components can further comprise an estimation component that can estimate a set of gradient values by evaluating the gradient at a set of time points.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can learn Lindblad parameters based on gradient values estimated from expectation values of an observable in accordance with one or more embodiments described herein.

FIG. 2 illustrates another block diagram of an example, non-limiting system that can learn Lindblad parameters based on gradient values estimated from expectation values of an observable in accordance with one or more embodiments described herein.

FIG. 3 illustrates example, non-limiting graphs that show ideal expectation values for an observable in accordance with one or more embodiments described herein.

FIG. 4 illustrates example, non-limiting graphs that show measured expectation values for an observable in accordance with one or more embodiments described herein.

FIG. 5 illustrates example, non-limiting equations that represent a gradient that can be computed based on respective expectation values corresponding to respective discrete time points in accordance with one or more embodiments described herein.

FIG. 6 illustrates an example, non-limiting graph showing exact and estimated Lindblad parameters in accordance with one or more embodiments described herein.

FIG. 7 illustrates another example, non-limiting graph showing exact and estimated Lindblad parameters in accordance with one or more embodiments described herein.

FIG. 8 illustrates a flow diagram of an example, non-limiting method that can be employed to learn Lindblad parameters based on gradient values estimated from expectation values of an observable in accordance with one or more embodiments described herein.

FIG. 9 illustrates a flow diagram of an example, non-limiting method that can be employed to estimate gradient values based on expectation values of an observable in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise a computation component that can compute a gradient based on respective expectation values corresponding to respective discrete time points. The computer executable components can further comprise an estimation component that can estimate a set of gradient values by evaluating the gradient at a set of time points.

Such embodiments of the system can provide a number of advantages, including determining more accurate Lindblad parameters as compared to some existing techniques and providing a more generalized approach to learning Lindblad parameters that is robust to state preparation errors and that does not depend on knowledge of the initial quantum state and time-evolved quantum states.

In one or more embodiments of the aforementioned system, the gradient can be a first-order derivative or a higher-order derivative of a curve fitted to the respective expectation values, and the gradient can be evaluated for respective time-evolved states of a quantum system.

Such embodiments of the system can provide a number of advantages, including generalizing the techniques disclosed herein to higher-order derivatives and evaluating the gradient for time-evolved states of a quantum system, thereby providing a more nuanced approach of learning the Lindblad parameters.

In one or more embodiments of the aforementioned system, the gradient can be a higher-order derivative of a curve fitted to the respective expectation values, and the gradient can be evaluated for a non-time-evolved state of a quantum system.

Such embodiments of the system can provide a number of advantages, including generalizing the techniques disclosed herein to higher-order derivatives and evaluating the gradient for a non-time-evolved state of a quantum system, thereby providing a more nuanced approach of learning the Lindblad parameters.

In one or more embodiments of the aforementioned system, a parameter learning component can learn a set of Lindblad parameters based on the set of gradient values.

Such embodiments of the system can provide a number of advantages, including learning parameters that describe a Lindblad noise model, recovering the exact quantum operations applied to one or more qubits and identifying the noise affecting a quantum system.

In one or more embodiments of the aforementioned system, a quantum process learning component can learn a parametrized Lindblad model based on the set of Lindblad parameters, where the parametrized Lindblad model can be applicable to a single-qubit quantum system or a multi-qubit quantum system.

Such embodiments of the system can provide a number of advantages, including learning a Lindblad noise model, recovering the exact quantum operations applied to one or more qubits and identifying the noise affecting a quantum system.

In one or more embodiments of the aforementioned system, the parametrized Lindblad model can be employable in error mitigation techniques.

Such embodiments of the system can provide a number of advantages, including eliminating the error affecting a quantum system and augmenting existing probabilistic error cancellation (PEC)/probabilistic error augmentation (PEA) techniques.

In one or more embodiments of the aforementioned system, a measurement component can generate the respective expectation values by measuring a plurality of observables at the respective discrete time points for a plurality of initial quantum states in a quantum system.

Such embodiments of the system can provide a number of advantages, including generating expectation values for time-evolved states of a quantum system corresponding to the respective discrete time points and generating expectation values for different combinations of observables and initial quantum states.

In one or more embodiments of the aforementioned system, a selection component can select the plurality of observables and the plurality of initial quantum states.

Such embodiments of the system can provide the advantage of selecting initial quantum states and observables that are suitable for the application of the techniques disclosed herein.

An embodiment in which the computation component computes a gradient based on respective expectation values corresponding to respective discrete time points, where the gradient is a first-order derivative or a higher-order derivative of a curve fitted to the respective expectation values, and where the gradient is evaluated for respective time-evolved states of a quantum system, has the advantage of determining more accurate Lindblad parameters as compared to some existing techniques and providing a more generalized approach to learning Lindblad parameters that is robust to state preparation errors and that does not depend on knowledge of the initial quantum state and time-evolved quantum states.

In an embodiment, the above described system can be employed to identify quantum operations originally applied to one or more qubits, by learning a Lindblad model describing the one or more qubits and to employ the information to calibrate a quantum gate or identify and extract the noise affecting the quantum system and eliminate the noise via classical post processing or other techniques such as error mitigation, error correction, etc.

According to various embodiments, the above-described system can be implemented as a computer-implemented method or as a computer program product.

A Lindblad equation (also known as the Lindblad master equation) describes how a quantum state changes over time. The Lindblad master equation can be given by Equation 1, wherein ρ describes the quantum state and

$$\frac{d}{dt} ρ$$

on the left-hand side of the equation describes the change of state as a function of time. The state change depends on the Hamiltonian term −i[H, ρ], wherein H represents the Hamiltonian. The dissipative term

$$\begin{matrix}{\sum }_{i , j} {β}_{i , j} ( {A}_{i} ρ {A}_{j}^{†} - \\ \frac{1}{2} \{ {A}_{j}^{†} {A}_{i} , ρ \} )\end{matrix}$$

describes how noise affects the quantum state. β_{i,j}, Aᵢ and Aⱼ are parameters, and the Lindblad equation can be described in terms of the parameters. The Lindblad equation can describe a Lindblad model.

A quantum operation (e.g., quantum gates, etc.) executed on a quantum device is noisy. For example, the Lindblad equation would ideally have only the Hamiltonian term −i[H, ρ]. However, the Lindblad equation also has the dissipative term as given by Equation 1, or it can have a ΔH term in addition to the Hamiltonian term, wherein the ΔH term describes a change resulting from applying pulses to qubits for a significantly long duration, etc. The dissipative term indicates that the target quantum operation is not implemented exactly due to the presence of noise, and it can be desirable to know the quantum operation that is applied as a result of the noise and employ the information to calibrate a quantum gate or identify and extract the noise affecting the quantum system. Thereafter, the noise can be eliminated via classical post processing or other techniques such as error mitigation, error correction, etc. This can be achieved by learning the Lindblad equation which describes a Lindblad model such as a Lindblad noise model.

Noise models are useful components in error mitigation. In PEC, existing techniques employ the sparse Pauli-Lindblad noise model which can be learned efficiently but involves Pauli twirling of the noise channel. The sparse Pauli-Lindblad noise model is therefore restricted to error mitigation of Clifford gates. That is, such existing techniques can derive specific noise models based on the Lindblad noise model, but such noise models can be applied only to Clifford gates. Clifford gates are a subset of quantum gates with some favorable properties. If a Clifford gate is over rotated, it will view the over rotation as noise and attempt to correct the noise, although rotating a Clifford gate slightly back can be much faster and cheaper. Existing techniques are also not aware of coherent errors, that can, in principle, be corrected without a sampling overhead.

Various embodiments of the present disclosure can be implemented to produce a solution to these problems. Embodiments described herein include systems, computer-implemented methods, and computer program products that can learn a Lindblad model based on gradient value estimates. In one or more embodiments, a learning procedure can be implemented to learn a Lindblad equation. For example, in one or more embodiments, a quantum process learning component can determine a set of initial quantum states and target observables and determine additional observables per initial quantum state and target observable combination. The initial quantum states and target observables can be selected by the quantum process learning component. Given an initial quantum state, the quantum process learning component can measure the corresponding observables at respective discrete time points and generate respective expectation values (also known as observable values) as a result of the measurements. Based on the respective expectation values, the quantum process learning component can compute a gradient and estimate gradient values, for the corresponding target observable, at a set of time points. As a result, a plurality of linear equations can be generated, with one linear equation generated per evaluation of the gradient. The quantum process learning component can select one or more rows of equations from the plurality of linear equations to generate a system of equations, based on the gradient values and/or the expectation values. Thereafter, the quantum process learning component can solve the system of equations, for example, to minimize the residual error, etc. By solving the system of equations, the quantum process learning component can obtain the model parameters or Lindblad parameters. Finally, the quantum process learning component can learn the Lindblad parameters and the corresponding Lindblad noise model.

Specifically, the quantum process learning component can select an initial quantum state β₀ and an observable O (i.e., a target observable). Per initial state β₀ and the target observable O, the quantum process learning component can derive additional observables (e.g., P, O, Q, etc.) to be measured to obtain all values in the system of equations. Thus, different observables (e.g., Tr([O, Pⱼ]ρₜ), Tr(OPᵢρₜPⱼ), Tr({O,PⱼPᵢ} Pt), etc.) can be measured and different expectation values (e.g., between negative (−) 1 and 1) can be generated. When measuring an observable on a quantum computer, the initial quantum state can change but the quantum operations and the qubits remain the same. As such, the Lindblad equation to be learnt can be defined over a set of qubits that remain constant throughout the learning procedure. Based on the expectation values, the quantum process learning component can derive gradients by first curve fitting the expectation values and employ the gradient to estimate gradient values. For example, a curve can be fit to a set of expectation values, and a derivative of the curve can be generated. The derivative of the curve can be the gradient which can be evaluated for different time points. That is, the gradient can be the derivative of a function fitted to the set of expectation values, and the derivative can be a function of different evolution times/circuit depths. The gradient can be evaluated at a set of evolution times/circuit depths, where each circuit depth corresponds to some unit evolution time. A time point employed to evaluate a gradient can generate a gradient value and a linear equation that can be included in the system of equations. The quantum process learning component can select the linear equations to be included in the system of equations based on the gradient values of the linear equations. For example, if the magnitude of a gradient value exceeds a defined threshold, the quantum process learning component can reject the corresponding linear equation or exclude the corresponding linear equation from the system of equations. That is, the quantum process learning component can select only the linear equations for which the magnitude of the gradient value is not very large (i.e., is smaller than a defined threshold). Each time point employed to evaluate the gradient can correspond to a circuit depth (i.e., a time duration for which a quantum operation is applied), and the quantum process learning component can generate one equation per measured circuit depth. Thus, if the magnitude of a gradient value at circuit depth 10 (i.e., time t=10) exceeds a defined threshold, the quantum process learning component can exclude the linear equation corresponding to that gradient value from the system of equations. In some embodiments, quantum process learning component can select the linear equations to be included in the system of equations based on the expectation values and/or the gradient values corresponding to the linear equations. It is desirable for the resulting system of equations to be full (column) rank to obtain a well-defined solution. The quantum process learning component can solve the resulting system of equations to obtain the Lindblad parameters that can be learnt by the quantum process learning component to learn a Lindblad model. Learning the Lindblad model can imply learning a Lindblad noise model which can be employed by the quantum process learning component to learn the noise in a quantum system and apply techniques such as error mitigation, error correction, etc. to eliminated or reduce the noise associated with quantum operations.

A generalized Lindblad equation can capture a generalization of an existing noise model. Learning a sparse Lindbladian, including the Hamiltonian term, can allow for better characterization of gate dynamics, and therefore correct both coherent and dissipative errors. In addition, the method described herein does not involve twirling of noise, which can make learning the noise model easier as compared to existing techniques. Further, the method does not depend on knowledge of the initial quantum state and time-evolved quantum states. Indeed, during processing of the data to learn the Lindblad parameters, the initial quantum state is entirely disregarded. Thus, the method herein is robust to state preparation errors and is only affected by measurement errors that can be mitigated by other techniques. The various embodiments herein and the corresponding error mitigation can be employed to augment existing PEC/PEA techniques. Additionally, the various embodiments herein can be generalized to architectures beyond superconducting qubits.

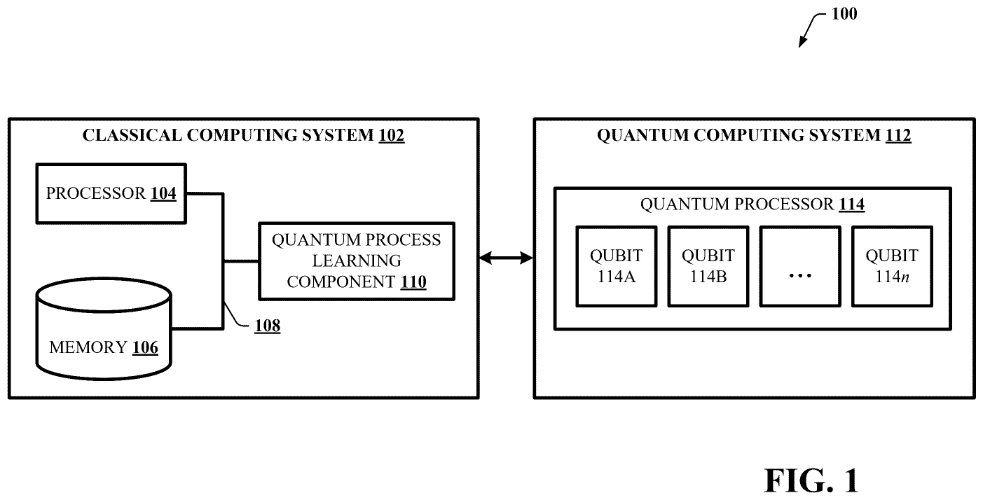

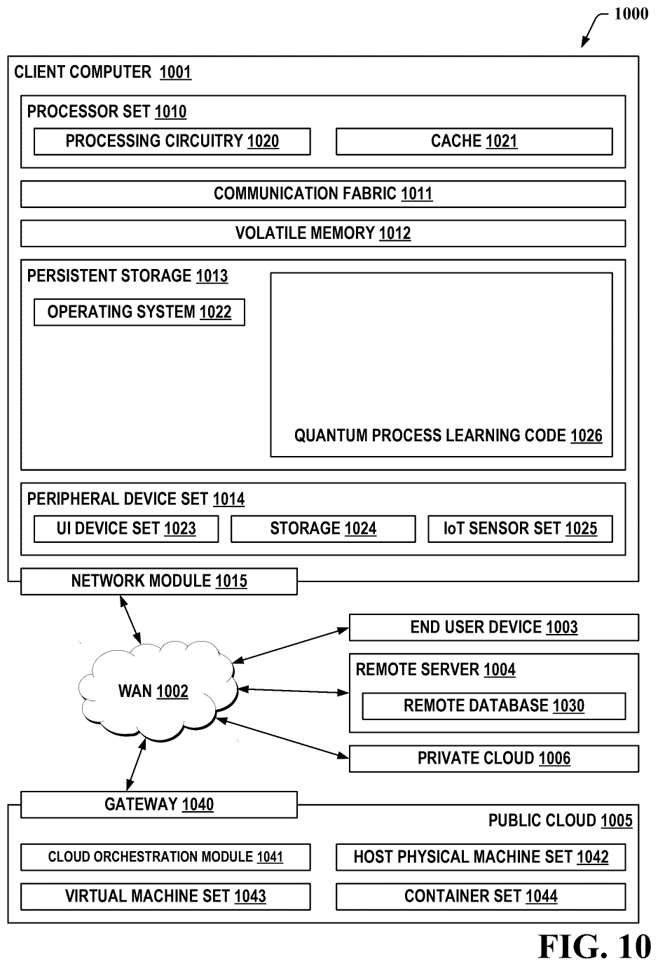

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, non-limiting system 100 can be associated with, such as accessible via, a computing environment 1000 described below with reference to FIG. 10, such that aspects of processing can be distributed between non-limiting system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can learn Lindblad parameters based on gradient values estimated from expectation values of an observable in accordance with one or more embodiments described herein.

Non-limiting system 100 and/or the components of non-limiting system 100 can be employed to use hardware and/or software to solve problems that are highly technical in nature (e.g., related to quantum computing, quantum noise models, error mitigation, etc.), that are not abstract and that cannot be performed as a set of mental acts by a human. Further, some of the processes performed may be performed by specialized computers for carrying out defined tasks related to learning quantum noise models based on gradient value estimates. Non-limiting system 100 and/or components of non-limiting system 100 can be employed to solve new problems that arise through advancements in technologies mentioned above and/or the like. Non-limiting system 100 can provide technical improvements to quantum computing technologies by improving the accuracy of results and providing techniques that are more robust to state preparation errors and allow for better characterization of gate dynamics, thereby correcting both coherent, and dissipative errors.

As illustrated in FIG. 1, non-limiting system 100 can comprise classical computing system 102 and quantum computing system 112. Classical computing system 102 can be coupled (operatively, communicatively, electrically, and/or like function) to quantum computing system 112. Quantum computing system 112 can comprise at least one quantum processor, such as quantum processor 114. Classical computing system 102 can comprise one or more components, such as a memory 106, processor 104, bus 108, and/or quantum process learning component 110. In an embodiment, quantum process learning component 110 can be comprised at least partially by quantum computing system 112. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit.

Discussion turns briefly to processor 104, memory 106 and bus 108 of non-limiting system 100. For example, in one or more embodiments, the non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer executable instructions that, upon execution by processor 104, can cause processor 104 and/or one or more other components of non-limiting system 100 (e.g., quantum process learning component 110, selection component 202, measurement component 204, computation component 206, estimation component 208 and/or parameter learning component 210) to perform one or more actions. In one or more embodiments, memory 106 can store computer executable components (e.g., quantum process learning component 110, selection component 202, measurement component 204, computation component 206, estimation component 208 and/or parameter learning component 210).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

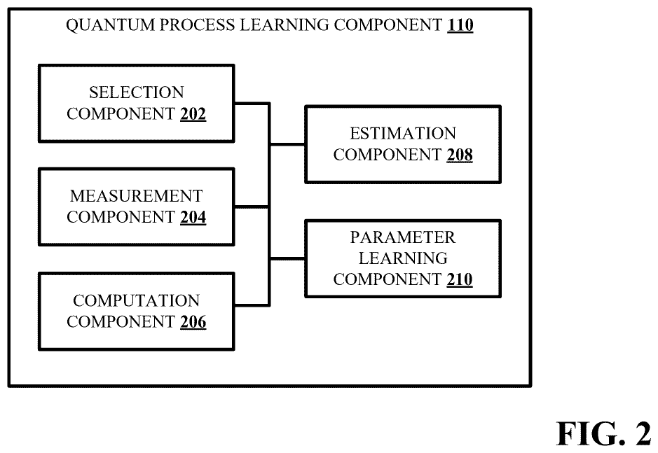

In one or more embodiments, classical computing system 102 can comprise quantum process learning component 110. As illustrated in FIG. 2, quantum process learning component 110 can comprise selection component 202, measurement component 204, computation component 206, estimation component 208 and/or parameter learning component 210. Classical computing system 102 can be coupled (operatively, communicatively, electrically, and/or like function) to quantum computing system 112 to perform the operations described by the various embodiments herein. For example, in one or more embodiments, quantum process learning component 110 can learn a Lindblad equation (also known as, a Lindblad master equation). A Lindblad equation describes how the state of a quantum system changes over time, and a Lindblad model refers to a specific application of the Lindblad equation. Stated differently, a Lindblad equation describes a Lindblad model. For example, a Lindblad noise model refers to an application of the Lindblad equation to model the noise affecting a quantum system. The Lindblad equation can be given by Equation 1.

$$\frac{d}{dt} ρ = - i [ H , ρ ] + {\sum }_{i , j} {β}_{i , j} ( {A}_{i} ρ {A}_{j}^{†} - \frac{1}{2} \{ {A}_{j}^{†} {A}_{i} , ρ \} ) , \qquad Equation 1$$

where β_{i,j}, Aᵢ and Aⱼ represent the parameters of the Lindblad equation. Additionally, β typically represents a positive semidefinite matrix, Aᵢ and Aⱼ are Lindblad operators, H represents a Hamiltonian, and ρ represents a density matrix. This time-evolution described by Equation 1 can be generated by the Lindbladian [symbol] (φ.

The Lindblad master equation describes the evolution of a quantum state and thus describes the process involved in the evolution. There are two forms of the Lindblad equation—the operator-sum representation and the GKSL form. Equation 1 gives the time-independent version of the Lindblad equation in Gorini-Kossakowski-Sudarshan-Lindblad (GKSL) form (setting h=1). In the GKSL form, β_{i,j} is diagonal and β=zero if i≠j. In this case, different operations Aᵢ and Aⱼ can exist. In some versions, the Lindblad equation can comprise terms such as Lᵢ and Lⱼ instead of Aᵢ and Aⱼ. A Lindbladian typically refers to the map [symbol] (ρ), and the Lindblad equation can be given by Equation 1 or equivalently written as

$$\frac{d}{dt} ρ = ℒ ( ρ ) .$$

A Lindblad model can represent a specific instance of [symbol] (ρ), wherein the terms α and β, and terms in the general notation (e.g., Aᵢ, Aⱼ or Lᵢ, Lⱼ) can be selected.

In one or more embodiments, quantum process learning component 110 can learn a parameterized Lindblad equation (also known as, a parametrized Lindblad master equation). The parametrized version of the Lindblad equation allows the learning of Lindblad parameters. For example, a Lindblad model can be specified in terms of operators and parameters, and the parameters can be learned via the learning procedure described by the various embodiments herein. The learning procedure can make the entire Lindbladian model accessible. Thereafter, noise extraction followed by error mitigation and/or other techniques can be performed. Learning a parametrized Lindblad master equation that corresponds to a quantum process, or closely approximates the quantum process, can be useful in applications such as gate calibration and noise learning for error mitigation. A parameterized Lindblad master equation can be learnt by learning Lindblad parameters, or by finding the best fit given measured data. For example, measurement component 204 can first parametrize the Lindbladian [symbol] according to Equation 2.

$$ℒ ( ρ ) = - i [ H , ρ ] + {\sum }_{i , j} {β}_{i , j} ( {P}_{i} ρ {P}_{j} - \frac{1}{2} \{ {P}_{j} {P}_{i} , ρ \} ) , where H = {\sum }_{i} {α}_{i} {P}_{i} , \qquad Equation 2$$

Pᵢ are Pauli operators, and α and β are parameters. Additionally, β represents a positive semidefinite matrix, H represents a Hamiltonian, and ρ represents a density matrix.

In one or more embodiments, the Lindblad model corresponding to Equations 1 and 2 can be application specific. For example, selection component 202 can select the Lindblad model based on the application (e.g., noise learning or another application). For the full Lindblad model, the number of parameters can grow exponentially with the number of qubits. However, in practice, the parameters α and β can be restricted to have non-zero coefficients only for local Paulis, which can help reduce the number of parameters and cause the number of parameters to grow linearly with the number of qubits.

Equation 2 shows a parametrization wherein there exist parameters β. During the parametrization, H can be split into a sum of Pauli terms that can also be parametrized by α. Additionally, H can be defined as H=ΣⱼαⱼPⱼ, and α and β can be represented as vectors of parameters that can be stacked (and subsequently employed for the equation A*x=b described in paragraph [0077]). Once the terms Pᵢ and Pⱼ are determined, the Lindbladian can be parametrized by α and β. Then, for an observable O and an initial quantum state, ρ₀, the equation given by Equation 3 can be defined. The trace (Tr) calculation given by Equation 3 can be performed by measurement component 204 to generate expectation values for the observable O.

For example, the observable O and the initial quantum state ρ₀ can be selected by selection component 202. Thereafter, measurement component 204 can measure the observable O at respective discrete time points, given the initial quantum state ρ₀. Measurement component 204 can measure the observable O on quantum computing system 112, and the measurement of the observable O at each discrete time point can generate an expectation value for the observable O. Additionally, measurement component 204 can measure a plurality of observables O for a plurality of initial quantum states ρ₀. In this regard, the observable O and the initial quantum state ρ₀ can represent one out of several combinations of observables and initial quantum states. For example, in one or more embodiments selection component 202 can select a set of initial quantum states and target observables for an application. For each combination of a target observable and an initial quantum state, measurement component 204 can measure the target observable on quantum computing system 112, given the initial quantum state, to generate respective expectation values corresponding to respective discrete time points. Additionally, as described in paragraph [0069], measurement component 204 can also measure derived observables for each combination of a target observable and an initial quantum state.

More specifically, in one or more embodiments, if a quantum state (e.g., ρ₀) is affected by a Lindbladian (as in the embodiments disclosed herein), then during the measurement of the observable, the quantum state can be transformed via a time evolution (given by [symbol] ) of the Lindbladian, where t corresponds to the circuit depth or the time duration for which one or more quantum operations can be applied. For example, during measurement of the observable O by measurement component 204, the initial quantum state po can be transformed via the time evolution of [symbol] . Doing so can generate a new quantum state and an expectation value of the observable O can be computed. Measurement component 204 can compute the trace of the new quantum state with the observable O according to Equation 3.

Equation 3: f_{0,ρ}_{₀}(t)=Tr( [symbol] ρ₀), wherein ρ₀ represents the initial quantum state, t represents the time, and [symbol] represents the time evolution of the Lindbladian.

### Trace:

To apply a quantum operation (e.g., quantum gates, etc.), a pulse can be applied to a qubit, and the quantum operation can be described by an exponentiation of the operators. In this case, t can represent the time evolution of the quantum system comprising the qubit, which indicates the duration of time for which the quantum operation is applied. The trace is implicit when an observable is measured, and the trace evaluates the observable. For example, [symbol] is a quantum operation on the initial quantum state ρ₀, wherein the quantum operation can be performed on quantum computing system 112, and the observable O represents the measurement process. The process of evaluating the observable O involves evaluating the initial quantum state ρ₀ as an expectation value. In this regard, Equation 3 describes a process that can occur after the quantum operations are applied to qubits in a quantum system. Additionally, Equation 3 represents a design specific to a variable.

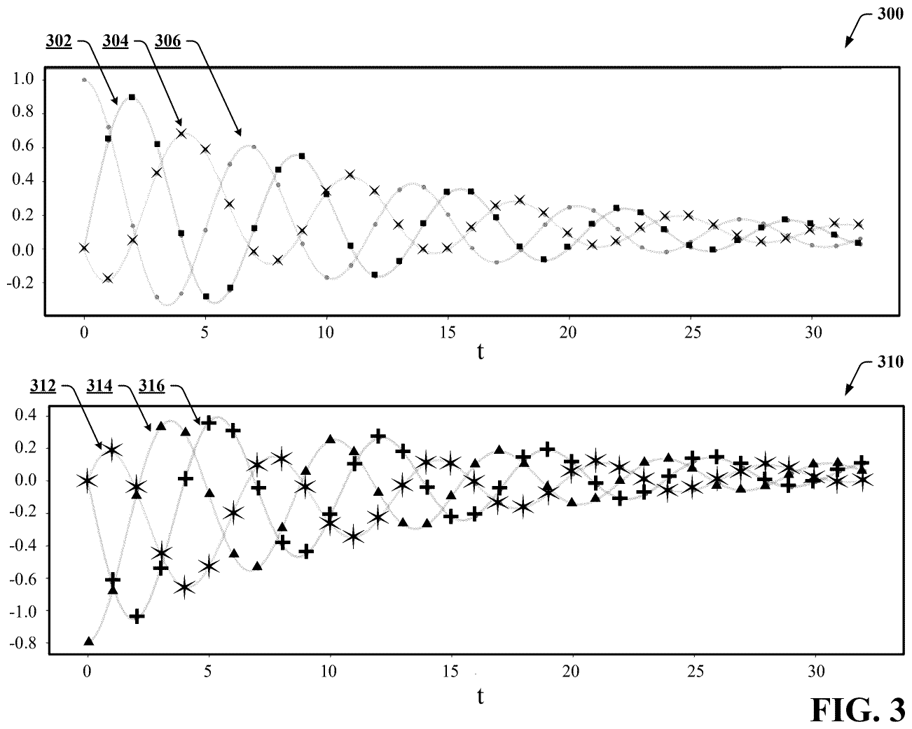

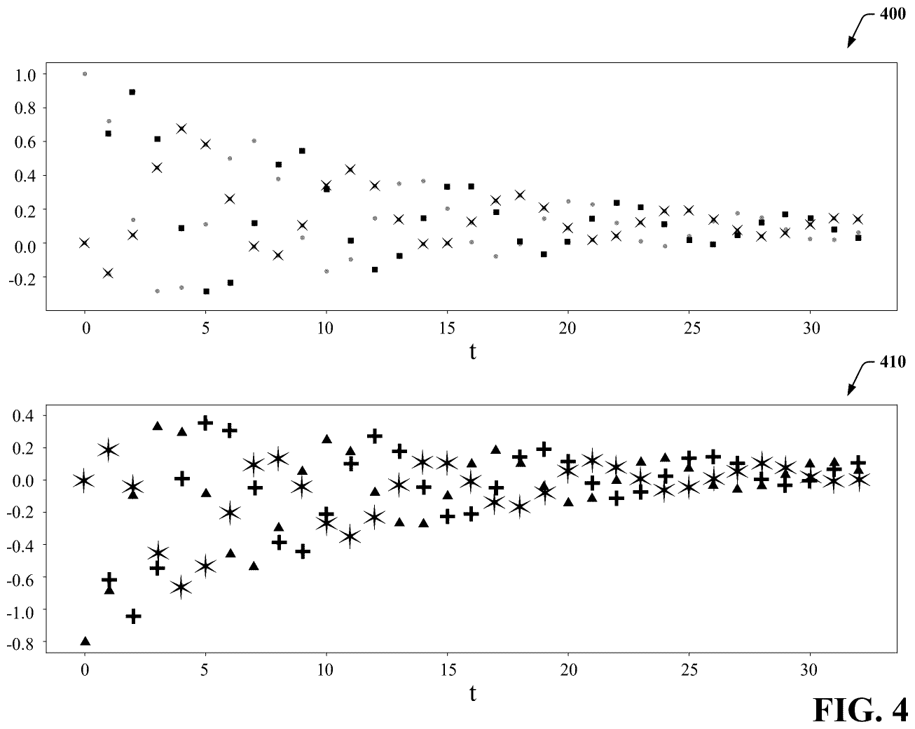

Typically, the function given by Equation 3 is continuous in time and can, in principle, be evaluated at any value of t>0. However, to measure the noise corresponding to a quantum gate, only discrete values of time can be considered. For example, it is desirable to consider the Lindbladian corresponding to one or more quantum gates, or simply the idle time with no quantum gates applied at all. Especially in the former case, the operation can be applied only an integer number of times, which indicates that an observable can be sampled or measured by measurement component 204 at only a discrete set of time points. That is, the term [symbol] can be applied only a discrete number of times (e.g., [symbol] , [symbol] , etc. as opposed to [symbol] , [symbol] , etc.). This process is illustrated in FIGS. 3 and 4 for an exemplary single-qubit Lindbladian. Thus, there can exist a discrete set of time points (e.g., 1=t1, t2, etc.) that can be equally or unequally spaced. For example, assuming t=1 (unit time), the terms [symbol] ρ₀, [symbol] ρ₀, etc. can be applied. As such, there can be a discrete number of applications of the unit operation. In this manner, measurement component 204 can measure the observable O at respective discrete time points to generate respective expectation values corresponding to the respective discrete time points.

In one or more embodiments, computation component 206 can compute a gradient based on the respective expectation values corresponding to the respective discrete time points. For example, given a discrete set of data points (i.e., expectation values), computation component 206 can interpolate or otherwise approximate the data points with a (piecewise) continuous curve. For example, computation component 206 can generate a fitted curve based on the respective expectation values by employing spline fitting or spline interpolation, basic polynomial fitting, piecewise polynomials, or other suitable techniques. Spline interpolation can generate an extremely good fit, provided the oscillations are not too fast (similar to Nyquist criteria in sampling). As a result, curves similar to those illustrated by non-limiting graphs 300 and 310 in FIG. 3 can be generated, wherein each curve can correspond to a different initial state for an observable, and each point on a curve can represent an expectation value generated for the observable given an initial state. In one or more embodiments, computation component 206 can compute a gradient based on a curve thus generated. In some implementations, the gradient can be computed as a first-order derivative, whereas in other implementations, the gradient can be computed as a higher-order derivative. Further, the gradient can be represented by an equation, such Equation 8.

In one or more embodiments, estimation component 208 can estimate a set of gradient values by evaluating the gradient at a set of time points, wherein each time point corresponds to a circuit depth. That is, the gradient can be the derivative of a function fitted to the respective expectation values, and the derivative can be a function of different evolution times (i.e., discrete time points)/circuit depths. As such, the gradient can be evaluated at a set of evolution times/circuit depths, where each circuit depth corresponds to some unit evolution time. Evaluating the gradient at a time point can generate a gradient value and a linear equation. Thus, multiple time points or a set of time points can generate multiple gradient values and linear equations. In one or more embodiments, estimation component 208 can select, based on a defined threshold (or another metric), the linear equations to be included in a system of equations, wherein the system of equations can be solved to obtain Lindblad parameters. For example, estimation component 208 can determine whether one or more gradient values of the set of gradient values have a magnitude greater than a defined threshold, and if so, estimation component 208 can exclude the linear equations corresponding to the gradient values from the system of equations. Otherwise, estimation component 208 can include the linear equations corresponding to the gradient values in the system of equations. In some embodiments, estimation component 208 can select the linear equations to be included in the system of equations based on the expectation values and/or the gradient values corresponding to the linear equations.

In some embodiments, estimation component 208 can evaluate the gradient for respective time-evolved states of a quantum system (i.e., a system of qubits employed to measure the observable O. Time-evolved states refer to quantum states at time t>0. In such embodiments, the gradient can be a first-order derivative or a higher order derivative of a curve fitted to the respective expectation values. In other embodiments, estimation component 208 can evaluate the gradient for a non-time-evolved state of a quantum system (i.e., a system of qubits employed to measure the observable O). A non-time-evolved state refers to a quantum state at time t=0. In such embodiments, the gradient can be a higher-order derivative of a curve fitted to the respective expectation values. In one or more embodiments, subsets of gradients (derivatives of curves) can be evaluated based on subsets of time points, and one or more estimates of gradient values can be combined.

In one or more embodiments, parameter learning component 210 can learn a set of Lindblad parameters (or Lindbladian parameters) based on the set of gradient values estimated by estimation component 208. For example, given several time points, parameter learning component 210 can aim to learn Lindblad parameters. For example, the gradient computed by computation component 206 can be mathematically described by Equation 5, and Equation 5 can be derived from Equations 1-4. Equation 4 describes how a quantum state changes as a function of time. Equation 4 represents another form of the Lindblad master equation given by Equation 1 and indicates that the rate of change of a quantum state can be represented by the Lindbladian. Additionally, each curve fitted to the respective expectation values generated by measurement component 204 can also indicate a rate of change (gradient) of the function given by Equation 3 with respect to time t. Thus, the Lindbladian can be written as a trace of a product of the observable O and the rate of change of the quantum state

$$\frac{d}{dt} {ρ}_{t} .$$

Since the Lindblad equation represents rate of change in a quantum state, the gradient is equal to the trace of the observable O multiplied with the Lindbladian, according to Equation 5.

$$\frac{d}{dt} {ρ}_{t} = ℒ ( {ρ}_{t} ) , \qquad Equation 4$$

wherein ρₜ represents a time-evolved quantum state corresponding to a certain evolution time or circuit depth.

$$\frac{d}{dt} {f}_{O , {ρ}_{0}} ( t ) = Tr ( O \frac{d}{dt} {ρ}_{t} ) = Tr ( O ℒ ( {ρ}_{t} ) ) \qquad Equation 5$$

For exemplary purposes, consider the observable O to be a Pauli observable. Then, the term Tr(O [symbol] (ρₜ)) can be expanded according to Equation 6 because if the observable O is chosen to be a Pauli observable, then a product of the observable O and a Pauli will also be a Pauli. The terms Tr([O,Pⱼ]ρₜ), Tr(OPᵢρₜPⱼ) and Tr({O,PⱼPᵢ}ρₜ) also represent observables. Thus, different derived values for O (e.g., O1, O2, etc.) can be generated, and the derived observables can also be measured by measurement component 204. It should be noted that in practice, the observable O can be a Pauli observable, a sum of Paulis, or another type of observable, depending on the application.

$$Tr ( O ℒ ( {ρ}_{t} ) ) = - i {\sum }_{j} {α}_{j} Tr ( O [ {P}_{j} , {ρ}_{t} ] ) + {\sum }_{i , j} {β}_{i , j} ( Tr ( {P}_{j} {OP}_{i} {ρ}_{t} ) - \frac{1}{2} Tr ( O \{ {P}_{j} {P}_{i} , {ρ}_{t} \} ) ) \qquad Equation 6$$

Equation 6 can be simplified to derive Equation 7.

$$Tr ( O ℒ ( {ρ}_{t} ) ) = - i {\sum }_{j} {α}_{j} Tr ( [ O , {P}_{j} ] {ρ}_{t} ) + {\sum }_{i , j} {β}_{i , j} ( Tr ( {OP}_{i} {ρ}_{t} {P}_{j} ) - \frac{1}{2} Tr ( \{ O , {P}_{j} {P}_{i} \} {ρ}_{t} ) ) \qquad Equation 7$$

It is known that the gradient of the observable O is real. If O and Pⱼ commute, the first term in Equation 7 is eliminated. Otherwise, the product OPⱼ will have a ±i term that absorbs the −i. For the second summation in Equation 7, all terms in the trace can be rotated to the form Tr(PⱼOPᵢρₜ). The total weight depends on commutation between O, Pᵢ, and Pⱼ, and will be {0, 1, 2}. When O commutes with Pᵢ and Pⱼ, the term vanishes. Equations 6 and 7 show how the trace of the observable O can be rewritten to generate the trace of the commutators O and Pⱼ (i.e., OPⱼ−PⱼO). For a target Pauli observable O, additional terms of the form POQ can be measured, wherein P and Q are Pauli terms, possibly equal to the identity. If O commutes with both P and Q, the trace term in the Lindbladian cancels and therefore does not need to be measured. This is certainly the case when the support of O is disjoint from P and Q, and by choosing weight-one observables O the various embodiments herein can therefore ensure that the weight is never larger than the combined weight of P and Q. With local model Paulis this also limits the observables to local observables.

Equation 8 can be further derived from Equations 5-7.

$$\frac{d}{dt} {f}_{O , {ρ}_{o}} ( t ) = - i {\sum }_{j} {α}_{j} Tr ( [ O , {P}_{j} ] {ρ}_{t} ) + {\sum }_{i , j} {β}_{i , j} ( Tr ( {OP}_{i} {ρ}_{t} {P}_{j} ) - \frac{1}{2} Tr ( \{ O , {P}_{j} {P}_{i} \} {ρ}_{t} ) ) \qquad Equation 8$$

Equation 8 gives the expanded version of Equation 5 and thus represents the gradient computed by computation component 206. Recall that estimation component 208 can estimate gradient values by evaluating the gradient at a set of time points, wherein each time point can correspond to a circuit depth. This generates a system of linear equations in the unknown parameters α and β with one equation (row) per derivative point. That is, evaluating the gradient for one time point generates one linear equation, and evaluating the gradient for multiple time points generates a system of linear equations. For example, the left-hand side of Equation 8 is a derivative of the function given by Equation 3 which describes a curve fitted to expectation values to generate the gradient, and the left-hand side can be measured and estimated. The right-hand side of Equation 8 includes some trace terms that can be measured or evaluated. Then, upon evaluating Equation 8 for a time point, the trace generates a numeric value, and a linear equation of the form N=N₁*α₁+N₂*α₂+ . . . +N_{{1,1}}*β_{{1,1}}+N_{{1,2}}*β_{{1,2}}+ . . . , or alternatively, N₁*α₁+N₂*α₂+ . . . +N_{{1,1}}*β_{{1,1}}+N_{{1,2}}*β_{{1,2}}+ . . . =N can be obtained for each time point, wherein Nᵢ, N_{{i,j}} and N are numbers. In some implementations, α and/or β represent a set of scalar parameters. In other implementations, α or β do not appear in the Lindblad model.

Upon evaluating Equation 8 for a sufficient number of circuit depths corresponding to time-evolved quantum states Pt and for a sufficient number of observables O and initial states ρ₀ an overdetermined system of equations of the form A*x=b or A*x≈b can be generated in the unknown parameters α and β, wherein x and b represent vectors, x is a vector of α and β values, and A represents a matrix (i.e., a regression matrix). For example, the right-hand side of Equation 8 can generate the coefficients of one row in the matrix A, the left-hand side of Equation 8 can generate one value in the vector b, and the parameters α and β, can become stacked together in a single vector x. This process can be visualized as stacking multiple equations of the form N₁*α₁+N₂*α₂+ . . . +N_{{1,1}}*β_{{1,1}}+N_{{1,2}}*β_{{1,2}}+ . . . =N on top of each other, such that the left-hand side of the equations can generate the matrix A and the vector x, and the right-hand side of the equations can generate the vector b.

In one or more embodiments, parameter learning component 210 can employ any appropriate technique to determine the best parameter values, given the system of linear equations and data. For example, parameter learning component 210 can employ least-squares minimization, weighted least-squares minimization or another suitable technique to solve the system of linear equations for the vector x. Given a sufficient number of expectation values, the matrix A can have more rows than columns. Although the coefficients in the regression matrix A depend on the initial state β₀, the exact value of the initial state ρ₀ can remain unknown. A full column rank indicates that there does not exist an x for which A*x=0, and x is a non-zero value. Stated differently, although the matrix entries in the matrix A and vector b depend on the choice of ρ₀, ρ₀ itself is not employed to solve the system of equations. This means that the techniques disclosed herein can be robust to state preparation errors. Additionally, readout errors can be reduced, for example, by employing a suitable readout-error mitigation method. Thus, the Lindblad parameters (i.e., α and β) can be obtained and learned by parameter learning component 210 based on the expectation values and the corresponding gradient values.

In one or more embodiments, quantum process learning component 110 can learn a parametrized Lindblad equation based on the set of Lindblad parameters learnt by parameter learning component 210, wherein the parametrized Lindblad equation can be applicable to a single-qubit quantum system or a multi-qubit quantum system. Recall that a Lindblad equation describes a Lindblad model. The Lindblad model can be learnt to learn the noise in a quantum system and perform techniques such as error mitigation, error correction, etc. to reduce or mitigate the noise.

The various embodiments of the present disclosure can be applicable for Lindblad (or Lindbladian) learning as well as Hamiltonian learning. Hamiltonian learning is a special case of Lindblad learning where β=0. Thus, the various embodiments herein present a method for Lindbladian learning based on gradient values (also known as, gradient value estimates, derivative estimates or observable derivative estimates) derived from expectation values (also known as, measured observable values) corresponding to time-evolved states (i.e., t≠0 as opposed to the non time-evolved state when t=0) as well as a method for Hamiltonian learning based on gradient values derived from expectation values corresponding to time-evolved states.

FIG. 2 illustrates a block diagram of an example, non-limiting system that can learn Lindblad parameters based on gradient values estimated from expectation values of an observable in accordance with one or more embodiments described herein. Repetitive description of like elements and/or processes employed in respective embodiments is omitted for sake of brevity.

FIG. 2 illustrates the system of quantum process learning component 110. As previously discussed, quantum process learning component 110 can comprise selection component 202, measurement component 204, computation component 206, estimation component 208 and parameter learning component 210. In various embodiments, quantum process learning component 110 can employ one or more of these components to compute a gradient based on respective expectation values corresponding to respective discrete time points and to further estimate a set of gradient values by evaluating the gradient at a set of time points. Based on the set of gradient values, quantum process learning component 110 can learn a set of Lindblad parameters and a Lindblad equation such as described by Equation 2.

In one or more embodiments, quantum process learning component 110 can employ the Lindblad equation to learn the noise in a quantum system and perform error mitigation techniques, error correction techniques, quantum gate updates, etc. to improve the estimates of expectation values. For example, in Equation 2, if the Hamiltonian H and the β values are known, the noise term

$${\sum }_{i , j} {β}_{i , j} ( {P}_{i} ρ {P}_{j} - \frac{1}{2} {P}_{j} {P}_{i} , ρ \} )$$

can be split to learn the noise. Once the noise is identified, quantum process learning component 110 can mitigate the noise with different techniques (e.g., error mitigation techniques, error correction techniques, quantum gate updates, etc.). The various embodiments herein can be expected to enable efficient and scalable noise learning for simultaneous gates. The noise models learnt can be employed in error mitigation, fine-tuning of gates, and potentially to inform codes/decoding algorithms in error correction. In this regard, the various embodiments herein can be employed to develop tools that can implement error mitigation for applications and observable estimation primitives. Additionally, the method disclosed herein can be tested in conjunction with matching error mitigation.

FIG. 3 illustrates example, non-limiting graphs 300 and 310 that show ideal expectation values for an observable in accordance with one or more embodiments described herein. Repetitive description of like elements and/or processes employed in respective embodiments is omitted for sake of brevity.

As discussed with reference to FIGS. 1 and 2, measurement component 204 can measure an observable O at respective discrete time points to generate respective expectation values corresponding to the respective discrete time points. Additionally, measurement component 204 can measure the observable O for different initial quantum states. In this regard, non-limiting graphs 300 and 310 illustrate different examples of an observable measured at discrete time points, given different initial quantum states. For example, in non-limiting graph 300, curves 302, 304 and 306 each show a time-evolved observable, that is, the expectation values of an observable as a function of time. Additionally, each curve corresponds to a different pair of an initial quantum state po and observable O.

In one or more embodiments, each observable can be measured for one or more qubits that remain consistent throughout the measurements. Thus, each curve in non-limiting graph 300 can correspond to one or more qubits. The points on each curve represent the ideal expectation values for the observable measured at different circuit depths, that is, at different times t (e.g., t=0, 1, 2, etc.). A similar concept is applicable to curves 312, 314 and 316 of non-limiting graph 310. Non-limiting graphs 300 and 310 show different combinations of initial quantum states and observables.

In non-limiting graphs 300 and 310, the curves are imaginary. In practice, an entity (e.g., hardware, software, machine, artificial intelligence (AI), neural network and/or user) can observe (e.g., on a graphical user interface (GUI)) only the points, such as illustrated in FIG. 4, and not the curves. In various embodiments, the curves fitted by computation component 206 (e.g., via spline interpolation, basic polynomial fitting, piecewise polynomials, or other suitable techniques) to interpolate the expectation values generated by measurement component 204 can look similar to the curves (e.g., 302, 304, 306) shown in non-limiting graphs 300 and 310. Accordingly, the gradient computed by computation component 206 can be the rate of change of such curves.

FIG. 4 illustrates example, non-limiting graphs 400 and 410 that show measured expectation values for an observable in accordance with one or more embodiments described herein. Repetitive description of like elements and/or processes employed in respective embodiments is omitted for sake of brevity.

Contrary to the ideal expectation values represented by the curves in non-limiting graphs 300 and 310, non-limiting graphs 400 and 410 show expectation values that can be measured (e.g., by measurement component 204) for observables for different initial quantum states. Non-limiting graphs 400 and 410 show different combinations of initial quantum states and observables. In FIGS. 3 and 4, like symbols in a graph can indicate the expectation values generated for like initial quantum states ρ₀. Based on such expectation values as shown in non-limiting graphs 400 and 410, computation component 206 can fit curves and compute gradients for each pair of an observable O and an initial quantum state ρ₀. It should be noted that the expectation values depend on the Lindblad equation, observable and initial quantum state, which can be different for different applications.

The techniques disclosed herein can be generalized to higher-order derivatives such as, for example, second-order derivatives, although first-order derivates can be more accurate than second-order derivatives. For example, as discussed with reference to FIGS. 1 and 2, in some implementations, the gradient computed by computation component 206 can be a first-order derivative or a higher-order derivative of a curve fitted to expectation values of an observable. For instance, starting with the second-order information for a simple Rx rotation with a Hamiltonian OX given by Equation 9, the set of equations given by Equation 10 can be computed.

$$\frac{d}{dt} Tr ( O ρ ( t ) ) = - i \frac{θ}{2} Tr ( [ O , X ] ρ ( t ) ) \qquad Equation 9$$

$$\begin{matrix}\frac{{d}^{2}}{{dt}^{2}} Tr ( O ρ ( t ) ) & = - i \frac{θ}{2} ( [ O , X ] \frac{d}{dt} ρ ( t ) ) \\ & = - i \frac{θ}{2} Tr ( [ O , X ] ( - i \frac{θ}{2} [ X , ρ ( t ) ] ) ) \\ & = - \frac{θ}{2} Tr ( ( OX - XO ) ( X ρ ( t ) - ρ ( t ) X ) ) \\ & = - \frac{θ}{2} Tr ( ( OXX - XOX - XOX + XXO ) ρ ( t ) ) \\ & = - \frac{{θ}^{2}}{4} Tr ( ( 2 O - 2 XOX ) ρ ( t ) )\end{matrix} \qquad Equation 10$$

If O and X commute, the right-hand side of the equation vanishes. Otherwise, it simplifies to −θ²Tr(Oρ(t)). A derivation similar to that given by Equations 9 and 10 can be applied to more general Lindbladians. When parametrized by α and/or β terms, Equation 10 can again generate a linear equation in those parameters on one side of the equation with a higher-order derivative on the other side of the equation, and the equation can be reordered as desired.

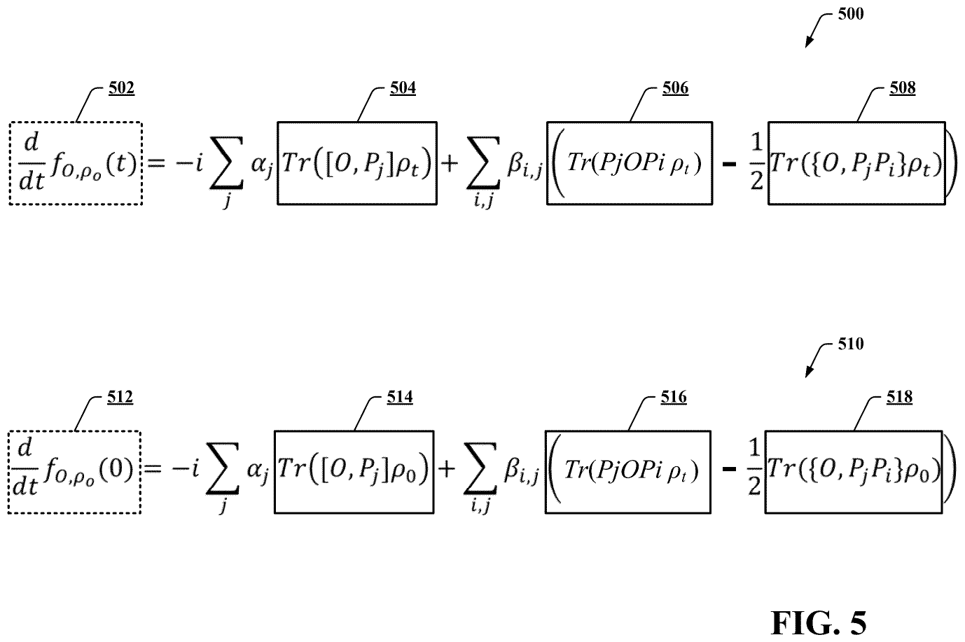

FIG. 5 illustrates example, non-limiting equations 500 and 510 that represent a gradient that can be computed based on respective expectation values corresponding to respective discrete time points in accordance with one or more embodiments described herein. Repetitive description of like elements and/or processes employed in respective embodiments is omitted for sake of brevity.

FIG. 5 is intended to highlight the advantages provided by the various embodiments described herein over existing techniques. Non-limiting equation 500 is identical to Equation 8 described with reference to FIGS. 1 and 2. For example, terms 502, 504, 506 and 508 represent a quantum state at time t, wherein t can be zero or a non-zero value. Non-limiting equation 510 shows Equation 8 evaluated for the non-time-evolved state t=0. For example, terms 512, 514, 516 and 518 represent a quantum state at time t=0. In non-limiting equations 500 and 510, the boxes with dashed lines on the left-hand side of the equations represent the gradient term, and the boxes with solid lines on the right-hand side of the equations represent trace terms.

To learn Lindblad parameters, some existing techniques choose a quantum state that is to be prepared and assume that a quantum computer can accurately generate computations for that quantum state. Based on the assumption, the expectation values for an observable are generated without evolving the quantum system. Thereafter, the gradient can be classically evaluated for only the initial quantum state ρ₀ (i.e., for time t=0) because the Lindbladian or Pt (i.e., quantum state at any other time) is unknown. That is, the gradient is evaluated only at time t=0 (at which point the quantum state is still ρ₀). Stated differently, after curve fitting some expectation values corresponding to a certain circuit depth, wherein the expectation values can be classically generated for different evolution times, the existing techniques evaluate the corresponding gradient only at a circuit depth zero (i.e., for time t=0, a non-time-evolved state of the quantum system). The gradient thus evaluated can be given by non-limiting equation 510. However, such existing techniques are not as versatile or useful as the various embodiments disclosed herein because ρₜ is unknown. To obtain ρₜ, the quantum system would need to be evolved over time with some Lindbladian, which cannot be done classically. As a result, the existing techniques differ from the various embodiments described herein in two primary ways:

1. The existing techniques measure only one or more expectation values of interest at different evolution times, as opposed to evolving a quantum system over discrete time points. For each observable O a polynomial fit is made, and the gradient is evaluated only at t=0.

2. In the existing approach, the term Tr(Oρ(t)) is computed at t=0, for the chosen one or more initial quantum states ρ(0).

On the contrary, the embodiments of the present disclosure evaluate the terms 502, 504, 506 and 508 by measuring observables at pt on a quantum computer (e.g., quantum computing system 112) instead of classically determining the expectation values. The various embodiments herein can therefore generate more accurate expectation values despite involving a greater number of measurements than the existing techniques. Another advantage provided by the various embodiments herein is that ρₜ does not need to be known because an observable is evaluated at Pt. This means that state preparation operations, initialization of a quantum computer or the implementation of ρ₀ which itself can be noisy, do not affect the method significantly, whereas in the existing techniques, if there is a mismatch between the actual ρ₀ and the intended ρ₀, an incorrect system of equations can be generated. Thus, the various embodiments herein can be robust and insensitive to state preparation errors and involve the measurement of multiple observables (locally, on a quantum computer). As a result, more expectation values can be generated depending on the circuit depth considered. For example, one equation can be generated per circuit depth, and a subspace of linear equations can be generated per initial quantum states.

The existing techniques described herein also employ the time derivative estimated based on a polynomial interpolation of the expectation values. As a result, a linear system of equations is generated in the model parameters, with one row per pair of an initial quantum state and an observable value. Although, the observable is evaluated at a series of time points, the gradient of the fitted curve is evaluated only at t=0. By contrast, the embodiments herein generate one equation for each time point (e.g., time-evolved states or a non-time-evolved state) corresponding to a circuit depth. That is, one linear equation can be generated per observable circuit depth. For example, if ten circuit depths are employed to fit a curve, existing techniques would add a single row (i.e., one equation) to the system of equations, whereas the embodiments disclosed herein would add ten rows (ten equations) to the system of equations based on the ten circuit depths. The ten equations can result from the selection procedure described in one or more embodiments, wherein equations can be selectively added to/omitted from the system of equations. This demonstrates an inherent limitation of the existing techniques, wherein computing the right-hand side of non-limiting equation 500 classically for time points with t>0 is impossible since the time-evolved state cannot be known. Finally, unlike the various embodiments disclosed herein, existing techniques are sensitive to state preparation errors in the observable measurements, since the left-hand side of non-limiting equation 500 is measured and the right-hand is computed.

In summary, existing techniques can generate only one equation, no matter how much of a circuit depth is considered, even though a greater circuit depth can give a better fit. Additionally, the existing techniques can sample a pair of a quantum state and an observable and measure only that observable. Since the matrix is computed classically, it can be determined a priori whether enough quantum states are sampled. Changes in the terms describing the Lindblad model can be described in the classically computed matrix, which can be done after data collection. With the existing techniques, observable data is generated at different circuit depths, but only results in a single equation. Therefore, a good estimation of the gradient at a circuit depth of zero is desirable. Additionally, the state preparation is assumed to be ideal classically and can be tuned, which can lead to a mismatch of data.

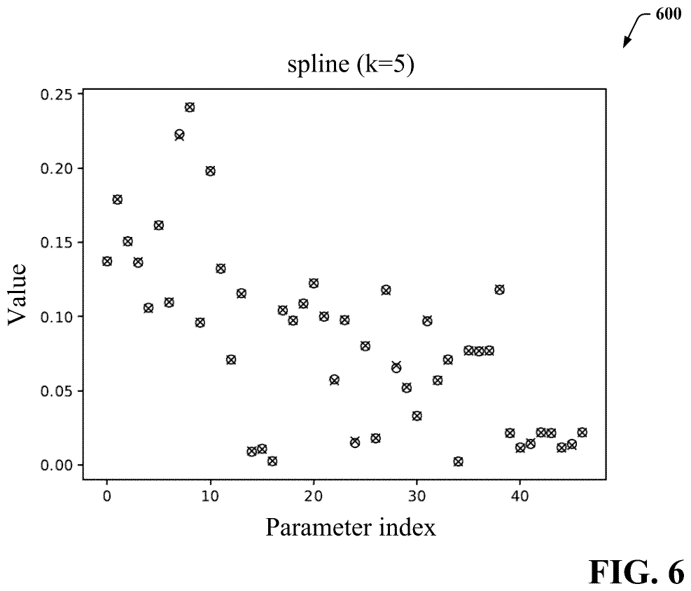

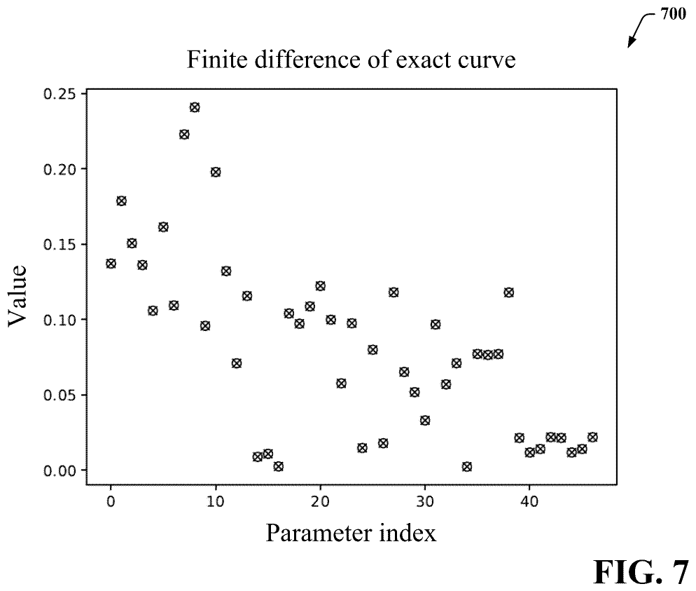

FIGS. 6 and 7 respectively illustrate example, non-limiting graphs 600 and 700 showing exact and estimated Lindblad parameters in accordance with one or more embodiments described herein. Repetitive description of like elements and/or processes employed in respective embodiments is omitted for sake of brevity.

Non-limiting graphs 600 and 700 show experimental data as proof of the methods and techniques disclosed in the various embodiments herein. The circles represent exact values of the Lindblad parameters α and β derived from a simulation, and the ‘X’ symbols represent estimated (approximated) values of α and β generated by employing the techniques disclosed herein. In general, non-limiting graphs 600 and 700 show different applications of the various embodiments herein, and non-limiting graph 700 shows an application with a better fit that can generate better data than that shown in non-limiting graph 600.

To generate the data in non-limiting graphs 600 and 700, a Lindbladian on four linearly connected qubits with random two-local Hamiltonian terms and single-qubit dissipative terms was considered. For non-limiting graph 600, the data recovery was performed by evaluating the gradients based on spline interpolation, and for non-limiting graph 700, the data recovery was performed with gradients obtained by finite differencing of the numerical time evolution, for comparison. To generate the estimated data shown in non-limiting graph 700, it was assumed that the values for the left-hand side of Equation 8 are known because the quantum states at t=0 and t=t₁, wherein t₁ is only slightly greater than zero, can be simulated. Thus, the curve can be assumed as being locally linear, and the gradient can therefore be estimated more accurately.

As evident from non-limiting graph 600 and 700, the exact and estimated Lindblad parameter values are not significantly different from one another, which indicates the efficacy of the methods and techniques disclosed herein. Two additional experimental results are presented hereinafter as further proof of the techniques disclosed herein.

Experiment 1:

A single-qubit experiment to learn the Lindbladian for the implemented SX gate (Rₓ(−π/2)) was performed. Data was acquired via IBM® Sapporo, and basic readout-error mitigation was performed via a single-qubit measurement matrix inversion. More specifically, an Rₓ(−π/2) gate was executed on a quantum device and applied to single qubits (qubit 1 (Q1), qubit 6 (Q6) or qubit 9 (Q9)). The quantum gate was covered by a Lindbladian which was unknown because of the quantum system being noisy. After applying the quantum gate, the learning procedure described in the various embodiments herein was employed to recover the Lindbladian. As part of the process, the matrices shown below were recovered after each qubit (Q1, Q6, Q9).

The ideal and recovered operators are as follows (SX on qubits 1, 6, and 9):

Matrix for the Rₓ(−π/2) gate showing ideal operators:

$$( \begin{matrix}0.707107 + 0. j & 0. + 0.707107 j \\ 0. + 0.707107 j & 0.7 7107 + 0 . j\end{matrix} )$$

Matrix for Q1 showing recovered operators for the Rₓ(−π/2) gate:

$$( \begin{matrix}0.709402 & + 0.000461 j & 0.000693 & + 0.704804 j \\ - 0.000693 & + 0.704 \; 804 j & 0.709402 & - 0.000461 j\end{matrix} )$$

Matrix for Q6 showing recovered operators for the Rₓ (−π/2) gate:

$$( \begin{matrix}0.709801 & - 0.000929 j & - 0.000785 & + 0.704402 j \\ 0.000785 & + 0.704 \; 402 j & 0.709801 & + 0.000 \; 929 j\end{matrix} )$$

Matrix for Q9 showing recovered operators for the Rₓ(−π/2) gate:

$$( \begin{matrix}0.708207 & + 0.000089 j & - 0.002264 & + 0.706001 j \\ 0.002264 & + 0.706001 j & 0.708207 & - 0.000089 j\end{matrix} )$$

The matrices for qubits 1, 6 and 9 represent the Lindblad parameters α and β in matrix form, but do not represent exact values of α and β because the exact values are unknown. Based on the matrices recovered, the quantum operation (e.g., Rₓ(−π/2)) applied to the qubits can be estimated. Evidently, the estimated values of α and β were very close to the ideal values. For example, a comparison of the elements in the matrices recovered for the qubits 1, 6 and 9 with the elements in the matrix for the quantum gate Rₓ (−π/2) shows that the recovered values for the Lindblad parameters are not significantly different from the ideal values of the Lindblad parameters. For example, in the recovered matrix for qubit 9, the first element has a value of 0.708207 which is only slightly different than the value 0.707107 in the matrix for the quantum gate. Thus, a quantum operation applied to one or more qubits can be recovered via the techniques disclosed herein.

### Experiment 2:

A single-qubit experiment to learn the Lindbladian for U=R_{Y}(0.45)R_{Z}(0.14)R_{X}(0.7) was performed, wherein U was transpiled to a combination of S_{X} and R_{Z} gates. Similar to Experiment 1, data was acquired via IBM® Sapporo, and basic readout-error mitigation was performed via a single-qubit measurement matrix inversion. The ideal and recovered operators (appropriate time evolution of Hamiltonian) are as follows (U on qubits 1, 6, and 9):

Matrix for U showing ideal operators:

$$( \begin{matrix}0.908102 & + 0.012269 j & - 0.232446 & - 0.34 \; 8095 j \\ 0.232446 & - 0.348 \; 095 j & 0.908102 & - 0.012 \; 269 j\end{matrix} )$$

Matrix for Q1 showing recovered operators for U:

$$( \begin{matrix}0.907861 & + 0.011199 j & - 0.23293 & - 0.348435 j \\ 0.232930 & - 0.348 \; 435 j & 0.907861 & - 0.011 \; 199 j\end{matrix} )$$

Matrix for Q6 showing recovered operators for U:

$$( \begin{matrix}0.907955 & + 0.012567 j & - 0.233536 & - 0.347737 j \\ 0.233536 & - 0.347737 j & 0.907955 & - 0.012 \; 567 j\end{matrix} )$$

Matrix for Q9 showing recovered operators for U:

$$( \begin{matrix}0.907238 & + 0.011993 j & - 0.234422 & - 0.348795 j \\ 0.234422 & - 0.348 \; 795 j & 0.907328 & - 0.011 \; 993 j\end{matrix} )$$

The matrices for qubits 1, 6 and 9 represent the Lindblad parameters α and β in matrix form, but do not represent exact values of α and β because the exact values are unknown. Based on the matrices recovered, the quantum operation (e.g., U) applied to the qubits can be estimated. Evidently, the estimated values of α and β were very close to the ideal values. For example, a comparison of the elements in the matrices recovered for the qubits 1, 6 and 9 with the elements in the matrix for the quantum operation U shows that the recovered values for the Lindblad parameters are not significantly different from the ideal values of the Lindblad parameters.

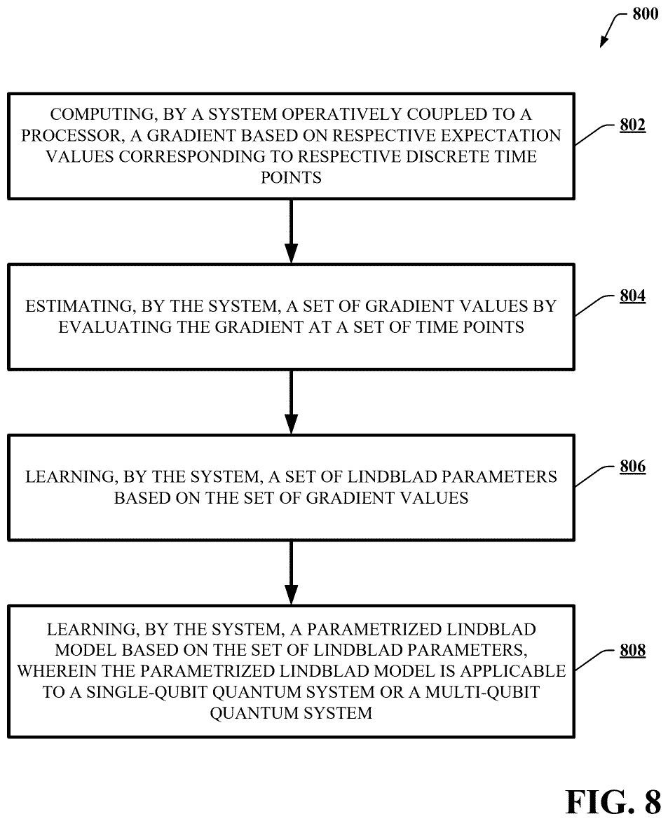

FIG. 8 illustrates a flow diagram of an example, non-limiting method 800 that can be employed to learn Lindblad parameters based on gradient values estimated from expectation values of an observable in accordance with one or more embodiments described herein. Repetitive description of like elements and/or processes employed in respective embodiments is omitted for sake of brevity.

At 802, non-limiting method 800 can comprise computing (e.g., by computation component 206), by a system operatively coupled to a processor, a gradient based on respective expectation values corresponding to respective discrete time points.

At 804, non-limiting method 800 can comprise estimating (e.g., by estimation component 208), by the system, a set of gradient values by evaluating the gradient at a set of time points.

At 806, non-limiting method 800 can comprise learning (e.g., by parameter learning component 210), by the system, a set of Lindblad parameters based on the set of gradient values.

At 808, non-limiting method 800 can comprise learning (e.g., by quantum process learning component 110), by the system, a parametrized Lindblad model based on the set of Lindblad parameters, wherein the parametrized Lindblad model is applicable to a single-qubit quantum system or a multi-qubit quantum system.

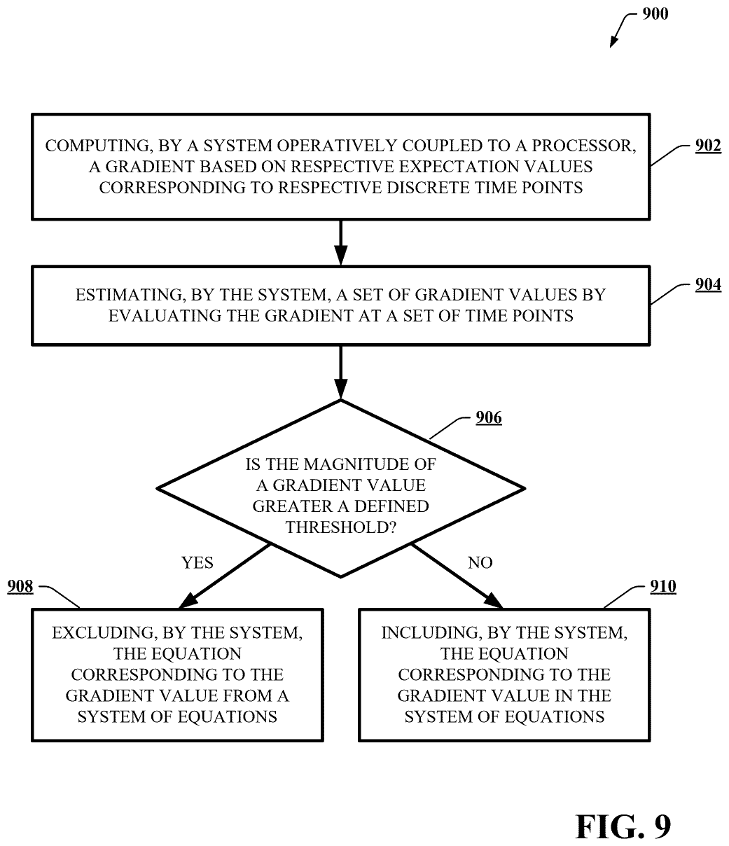

FIG. 9 illustrates a flow diagram of an example, non-limiting method 900 that can be employed to estimate gradient values based on expectation values of an observable in accordance with one or more embodiments described herein. Repetitive description of like elements and/or processes employed in respective embodiments is omitted for sake of brevity.

At 902, non-limiting method 900 can comprise computing (e.g., by computation component 206), by a system operatively coupled to a processor, a gradient based on respective expectation values corresponding to respective discrete time points.

At 904, non-limiting method 900 can comprise estimating (e.g., by estimation component 208), by the system, a set of gradient values by evaluating the gradient at a set of time points.

At 906, non-limiting method 900 can comprise determining (e.g., by estimation component 208), by the system, whether the magnitude of a gradient value is greater than a defined threshold.

If yes, then at 908, non-limiting method 900 can comprise excluding (e.g., by estimation component 208), by the system, the equation corresponding to the gradient value from a system of equations (i.e., a system of equations employable to learn Lindblad parameters).

If not, then at 910, non-limiting method 900 can comprise including (e.g., by estimation component 208), by the system, the equation corresponding to the gradient value in the system of equations.

For example, in various embodiments, once the respective expectation values have been fitted with a curve, the gradient based on the curve can be evaluated at a plurality of time points. Each evaluation of the gradient at a time point can generate a linear equation. In various embodiments, upon generation of respective linear equations based on the gradient and the respective time points, a selection procedure can be implemented by estimation component 208, wherein estimation component 208 can select the linear equations (i.e., resulting from an evaluation of gradients) to be included in a system of equations that can be solved to obtain Lindblad parameters. Estimation component 208 can select the linear equations based on respective gradient values for respective linear equations. For example, if the magnitude of a gradient value (also known as a derivative value) corresponding to a linear equation is greater than a defined threshold (which, for example, can indicate a less trustworthy linear equation), estimation component 208 can exclude the linear equation from the system of equations. In an implementation, estimation component 208 can select the linear equations based on the corresponding expectation values (also known as observable values), rather than the gradient values. In another implementation, estimation component 208 can select the linear equations based on both the corresponding expectation values, and the gradient values. Stated differently, in various embodiments herein, a selection procedure can be implemented, wherein the selection procedure can determine which linear equations are included in the system of equations based on respective gradient values and/or expectation values of respective linear equations.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as quantum process learning code 1026. In addition to block 1026, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1026, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1026 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1026 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a measurement component that generates respective expectation values by measuring a plurality of observables at respective discrete time points for a plurality of initial quantum states in a quantum system;
a computation component that computes a gradient based on the respective expectation values corresponding to respective discrete time points; and
an estimation component that estimates a set of gradient values by evaluating the gradient at a set of time points.

2. The system of claim 1, wherein the gradient is a first-order derivative or a higher-order derivative of a curve fitted to the respective expectation values, and wherein the gradient is evaluated for respective time-evolved states of a quantum system.

3. The system of claim 1, wherein the gradient is a higher-order derivative of a curve fitted to the respective expectation values, and wherein the gradient is evaluated for a non-time-evolved state of a quantum system.

4. The system of claim 1, further comprising:
a parameter learning component that learns a set of Lindblad parameters based on the set of gradient values.

5. The system of claim 4, further comprising:
a quantum process learning component that learns a parametrized Lindblad model based on the set of Lindblad parameters.

6. The system of claim 5, wherein the parametrized Lindblad model is applicable to a single-qubit quantum system or a multi-qubit quantum system.

7. The system of claim 5, wherein the parametrized Lindblad model learns noise in a quantum system and reduces the noise thereby performing error mitigation.

8. The system of claim 1, further comprising:
a selection component that selects the plurality of observables and the plurality of initial quantum states.

9. A computer-implemented method, comprising:
generating, by a system operatively coupled to a processor, respective expectation values by measuring a plurality of observables at respective discrete time points for a plurality of initial quantum states in a quantum system;
computing, by the system, a gradient based on the respective expectation values corresponding to the respective discrete time points; and
estimating, by the system, a set of gradient values by evaluating the gradient at a set of time points.

10. The computer-implemented method of claim 9, wherein the gradient is a first-order derivative or a higher-order derivative of a curve fitted to the respective expectation values, and wherein the gradient is evaluated for respective time-evolved states of a quantum system.

11. The computer-implemented method of claim 9, wherein the gradient is a higher-order derivative of a curve fitted to the respective expectation values, and wherein the gradient is evaluated for a non-time-evolved state of a quantum system.

12. The computer-implemented method of claim 9, further comprising:
learning, by the system, a set of Lindblad parameters based on the set of gradient values.

13. The computer-implemented method of claim 12, further comprising:
learning, by the system, a parametrized Lindblad model based on the set of Lindblad parameters.

14. The computer-implemented method of claim 13, wherein the parametrized Lindblad model is applicable to a single-qubit quantum system or a multi-qubit quantum system.

15. The computer-implemented method of claim 13, further comprising:
learning, by the system, the parametrized Lindblad model noise in a quantum system and reducing the noise thereby performing error mitigation.

16. The computer-implemented method of claim 9, further comprising:
selecting, by the system, the plurality of observables and the plurality of initial quantum states.

17. A computer program product for quantum process learning, the computer program product comprising a computer readable storage medium having program instructions embodied therewith, the program instructions executable by a processor to cause the processor to:
generate, by the processor, respective expectation values by measuring a plurality of observables at respective discrete time points for a plurality of initial quantum states in a quantum system;
compute, by the processor, a gradient based on the respective expectation values corresponding to the respective discrete time points; and
estimate, by the processor, a set of gradient values by evaluating the gradient at a set of time points.

18. The computer program product of claim 17, wherein the gradient is a first-order derivative or a higher-order derivative of a curve fitted to the respective expectation values, and wherein the gradient is evaluated for respective time-evolved states of a quantum system.

19. The computer program product of claim 17, wherein the gradient is a higher-order derivative of a curve fitted to the respective expectation values, and wherein the gradient is evaluated for a non-time-evolved state of a quantum system.

20. The computer program product of claim 17, wherein the program instructions are further executable by the processor to cause the processor to:
learn, by the processor, a set of Lindblad parameters based on the set of gradient values; and
learn, by the processor, a parametrized Lindblad model based on the set of Lindblad parameters, wherein the parametrized Lindblad model is applicable to a single-qubit quantum system or a multi-qubit quantum system.
